(19) United States
(12) Patent Application Publication
(10) Pub. No.: US 2012/0038336 A1
(43) Pub. Date: Feb. 16, 2012

(54) DIGITAL PWM CONTROL MODULE

(76) Inventor: Christopher V Zahrt, Shell Rock, IA (US)

(21) Appl. No.: 13/206,177

(22) Filed: Aug. 9, 2011

Related U.S. Application Data
(60) Provisional application No. 61/373,098, filed on Aug. 12, 2010.

(51) Int. Cl. G05F 1/10

(52) U.S. Cl. 323/282

(57) ABSTRACT

A digital pulse width modulation (PWM) control module for controlling one or more loads includes a transistor operatively connected to and configured to drive one of the loads and a microcontroller programmed to turn the transistor on and off in accordance with a pulse width modulated signal, the pulse width modulated signal comprising a start up delay, a pull in time, and a duty percentage associated with a hold cycle. The control module allows for limiting total current draw by creating a latching type circuit. In addition, a diode bridge may be used to provide polarity protection. Groups of control modules may have an associated delay to assist in reducing rush-in current.

### CROSS-REFERENCE TO RELATED APPLICATIONS

This application claims priority under 35 U.S.C. §119 of a provisional application Ser. No. 61/373,098 filed Aug. 12, 2010, and which application is hereby incorporated by reference in its entirety.

### FIELD OF THE INVENTION

The present relates to a digital pulse width modulation (PWM) control module suitable for use in controlling solenoids. More particularly, but not exclusively, the present invention relates to providing digital pulse width modulation of solenoids used in agricultural equipment such as planters and sprayers.

### BACKGROUND OF THE INVENTION

The background of the invention is provided in the context of solenoids used in off-highway and agricultural equipment. Although the background is described in this context, the present invention may be used in various other applications and should not be limited by the background set forth herein.

In off-highway and agricultural equipment such as foam marker equipment and planters mechanical solenoids are used for various purposes including control of valves. Often times multiple mechanical solenoids are used. For example, in a planter with 24 or 36 rows or larger, there may be one or more solenoids associated with each row. Solenoids may be used for operating electric clutches to disengage seed drop when overlapping a previously planted area, operating valves to control air which disengages pneumatic clutches, operating valves to directly control fertilizer placed on or near the seed, and controlling air or hydraulic valves to adjust down pressure on individual row units for precise seed depth placement. In some planters, solenoids may be used for as many as three of these functions. When all of the solenoids are activated at the same time, there is a significant in-rush current. It would be desirable to limit this in-rush current.

In addition, once solenoids are activated, significant current draw is used to maintain that state. It would be advantageous to limit this current draw.

What is needed is an improved control module suitable for use in controlling solenoids which addresses these issues.

### SUMMARY

Therefore, it is an object, feature, or advantage of the present invention to improve over the state of the art.

It is a further object, feature, or advantage of the present invention to provide a digital PWM control module suitable for use in controlling solenoids including solenoids associated with off-highway and agricultural equipment.

It is a still further object, feature, or advantage of the present invention to provide a digital PWM control module with a diode which protects other electrical components in the system, including computers and electronics.

It is another object, feature, or advantage of the present invention to provide polarity protection for the diode to prevent reverse polarity hook-up during installation or repairs from burning out the diode.

A still further object, feature, or advantage of the present invention is to limit total current draw by creating a latching type circuit which reduces apparent voltage after actuation by using the PWM portion of the system.

Another object, feature, or advantage of the present invention is to keep the solenoid temperature cooler so that when actuated it will have more force.

Yet another object, feature, or advantage of the present invention is to provide for total current limiting at time of actuation of a group of solenoids by having a programmable delay in actuation so that the solenoids fire at different times.

These and/or other objects, features, or advantages of the present invention will become apparent from the specification and claims that follow. No single embodiment need exhibit each and every one of these advantages.

According to one aspect of the present invention, a digital pulse width modulation (PWM) control module for controlling a load includes a transistor operatively connected to and configured to drive the load and a microcontroller programmed to turn the transistor on and off in accordance with a pulse width modulated signal, the pulse width modulated signal comprising a start up delay, a pull in time, and a duty percentage associated with a hold cycle. The control module allows for limiting total current draw by creating a latching type circuit. The load(s) may include solenoids or other devices. In addition, a diode bridge may be used to provide polarity protection.

According to another aspect of the present invention, a system is provided. The system includes a plurality of digital pulse width modulation (PWM) control modules, each for controlling a load and comprising (a) a transistor operatively connected to and configured to drive the load, (b) a microcontroller programmed to turn the transistor on and off in accordance with a pulse width modulated signal, the pulse width modulated signal comprising a start up delay, a pull in time, and a duty percentage associated with a hold cycle. Each microcontroller has an associated delay to thereby assist in reducing rush-in current.

### BRIEF DESCRIPTION OF THE DRAWINGS

FIG. 1 is a circuit diagram illustrating one embodiment of the digital PWM control module of the present invention.

FIG. 2 illustrates one example of a series of pulses which may be generated with the digital PWM control module.

FIG. 3 is a block diagram showing a plurality of digital PWM control modules with varying startup delays.

FIG. 4 illustrates an agricultural or off-road vehicle, a planter, equipped with a plurality of digital PWM control modules.

FIG. 5 illustrates an agricultural or off-road vehicle in the form of a sprayer equipped with a plurality of digital PWM control modules.

### DETAILED DESCRIPTION

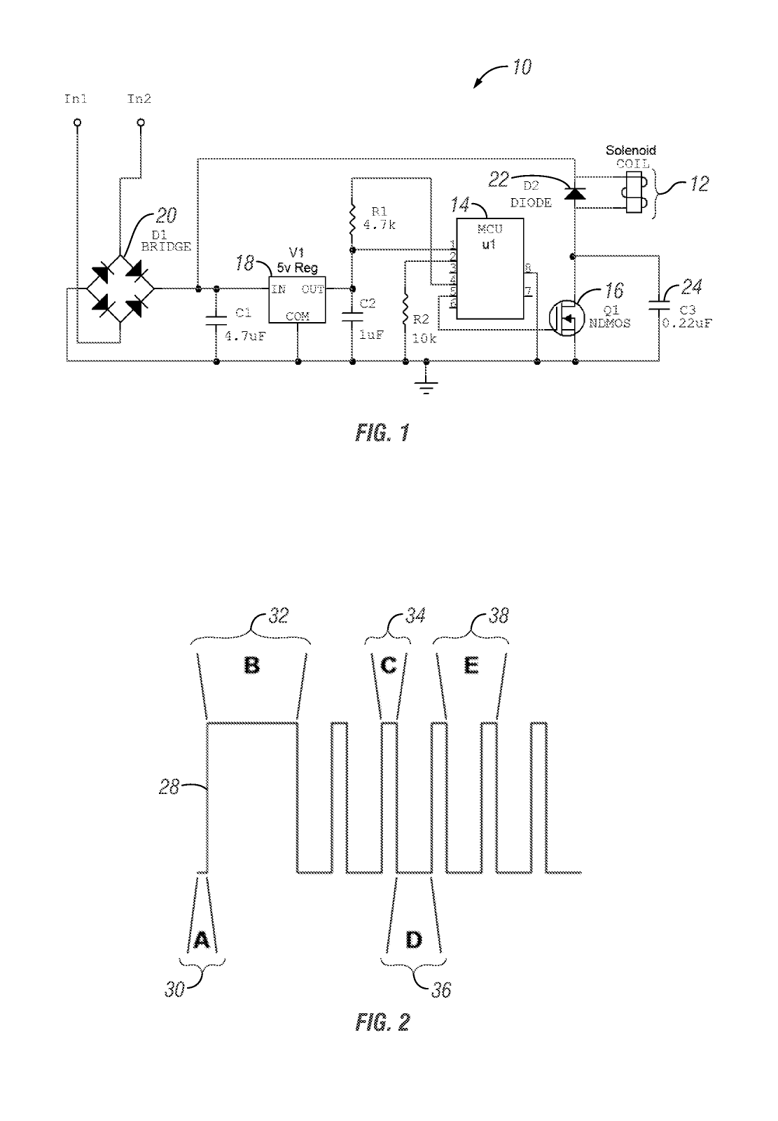

A digital PWM control module provides for generating an output signal which may be used to drive a mechanical solenoid, a motor or other device. FIG. 1 illustrates the digital PWM control module in the form of a pulse width modulated solenoid driver circuit. For purposes here, specific values of component parts are shown in the circuit diagram and examples of voltage specifications are provided. It is to be understood, however, that these component parts may vary significantly based in part on the design specifications for a particular application. It is further to be understood that various substitutions of component parts may be made.

The circuit 10 of FIG. 1 is designed to accept a 7 to 25 volt DC input (In1, In2) and drives a mechanical solenoid 12 of similar specification. The input is rectified with a diode bridge (D1) 20 so that polarity is not a concern when being connected. A voltage regulator (V1) 18 regulates voltage, in this case to 5 volts.

A microcontroller (u1) 14 is preprogrammed with all the timings related to load, in this case the mechanical solenoid. FIG. 2 illustrates examples of these timings. The timings may include the startup delay 30, the pull in time 32, and the duty percentage (34, 36, 38) for the hold cycle. These settings can be adjusted prior to the microcontroller being programmed. Returning to FIG. 1, the program on the microcontroller switches a MOSFet transistor (Q1) 16 on and off controlling the solenoid. A clamping diode (D2) 22 is present to reduce the EMF created by the solenoid when it is powered down. Electromagnetic interference (EMI) is reduced by a capacitor (C3) 24.

The circuit of FIG. 1 provides a number of advantages when controlling a solenoid or other device. Note that the diode (D2) 22 protects other electrical components in the system including computers and electronics. The diode bridge (D1) 20 prevents reverse polarity hook-up during installation or repairs from burning out the diode as well as protecting other components in the circuit. The use of PWM to drive the transistor (Q1) 16 allows for limiting total current draw by creating a latching type circuit. This also assists in keeping the solenoid temperature cooler so when actuated it will have more force.

In addition, total current limiting at a time of actuation of a group of solenoids may be performed by having a programmable delay in actuation so that the solenoids fire at different times. This may involve varying a value in the range from 0-250 milliseconds. This prevents one large in-rush current.

Where a group of solenoids are used, there may be a separate control module for each group. A delay before firing may be determined by using a number representative of the delay. For example, a value in the range from 0-250 may represent a delay of 0 to 250 milliseconds. This number may be generated in programming or may be embedded in the microcontroller. Thus in applications where there are groups of solenoids, such as in a 16 row planter with one solenoid per row, different values for the delay be used for each separate control module or else random determination of delays may be used. This prevents the solenoids from firing at the same time, or makes statistically highly improbable.

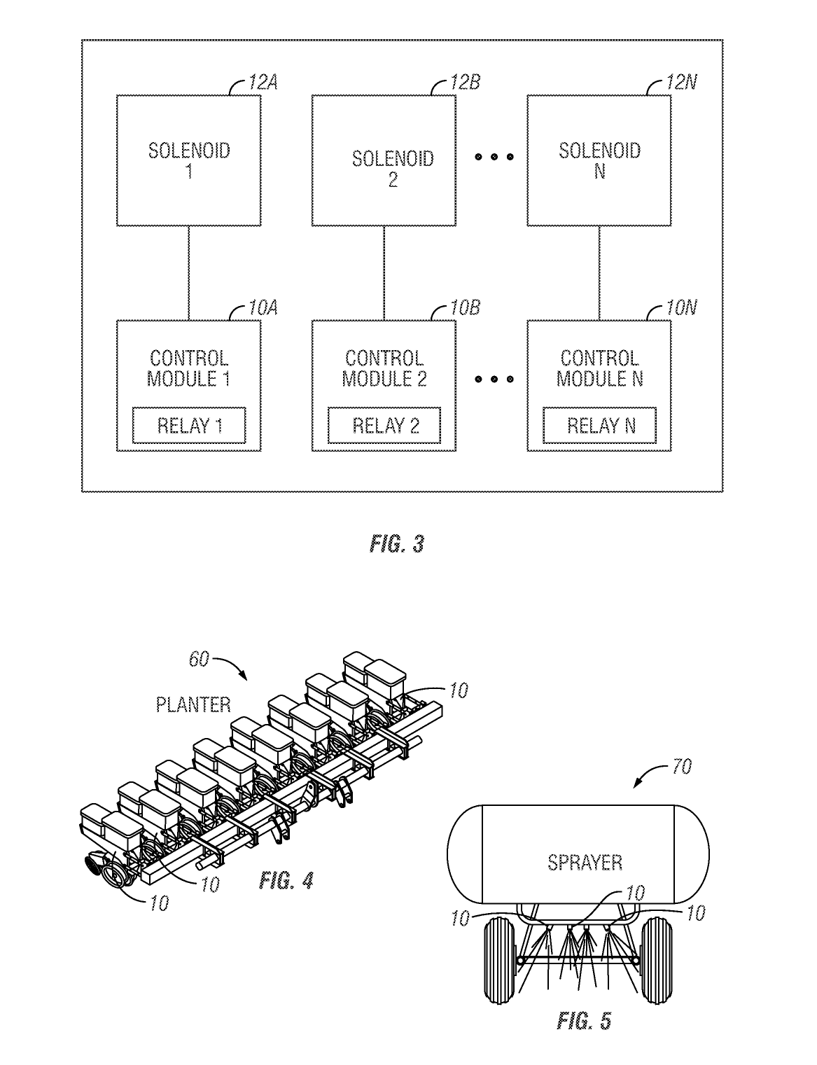

FIG. 3 illustrates an example of multiple solenoids and multiple control modules. In FIG. 3 N solenoids (where N>2) is shown (12A, 12B, 12N). Each of the solenoids is operatively connected to a control module 10A, 10B, 10N. Each of the control modules 10A, 10B, 10N has a startup delay. As previously explained, these startup delays are programmed so that the solenoids fire at different times to prevent a large in-rush current.

FIG. 4 illustrates one example of an agricultural implement, a planter 60, which includes multiple solenoids and multiple control modules 10.

FIG. 5 illustrates another example of an agricultural or off-road implement in the form of a sprayer 70 which includes multiple solenoids and multiple control modules.

Although discussed primarily in the context of solenoids, it is to be appreciated that the control module may be used with other types of components. For example, it could be used with small motors, without the PWM portion being implemented in the program. In this way, diode polarity protection and in-rush current limiting on a group of motors could be provided. Additionally, the PWM feature could be implemented for one, some or all of a group of motors if a slower speed was desired.

Therefore methods and systems associated with a control module have been disclosed. The present invention contemplates variations in whether a solenoid, motor, or other device is being driven, variations in the number of devices being driven, variations in the timing of pulses where used, and other variations, options, and alternatives. The present invention is not to be limited to any preferred embodiment shown.

1. A digital pulse width modulation (PWM) control module for controlling a load, comprising:
a transistor operatively connected to and configured to drive the load;
a microcontroller programmed to turn the transistor on and off in accordance with a pulse width modulated signal, the pulse width modulated signal comprising a start up delay, a pull in time after the startup delay, and a duty percentage associated with a hold cycle after the pull in time.

2. The control module of claim 1 further comprising a diode bridge operatively connected between voltage inputs.

3. The control module of claim 2 further comprising a voltage regulator electrically connected to the diode bridge, the voltage regulator providing an input voltage to the microcontroller.

4. The control module of claim 1 wherein the load comprises a solenoid.

5. The control module of claim 1 wherein the load comprises a motor.

6. A system, comprising:
a plurality of digital pulse width modulation (PWM) control modules, each for controlling a load and comprising (a) a transistor operatively connected to and configured to drive the load, (b) a microcontroller programmed to turn the transistor on and off in accordance with a pulse width modulated signal, the pulse width modulated signal comprising a start up delay, a pull in time after the startup delay, and a duty percentage associated with a hold cycle after the pull in time;
wherein the startup delay varies across the plurality of digital PWM control modules to assist in reducing rush-in current.

7. The system of claim 6 wherein each startup delay is determined randomly at run-time.

8. The system of claim 6 wherein each startup delay is pre-set.

9. The system of claim 7 wherein the load is a solenoid.

10. An article of agricultural equipment comprising:
a plurality of solenoids;
a plurality of digital pulse width modulation (PWM) control modules, each for controlling at least one of the solenoids and comprising (a) a transistor operatively connected to and configured to drive the load, (b) a microcontroller programmed to turn the transistor on and off in accordance with a pulse width modulation signal comprising a startup delay, a pull in time after the startup delay, and a duty percentage associated with a hold cycle after the pull in time;
wherein the startup delay varies across the plurality of the digital PWM control modules to assist in reducing rush-in current.
